(19) United States
(12) Patent Application Publication
(10) Pub. No.: US 2008/0009563 A1
(43) Pub. Date: Jan. 10, 2008

(54) Method for the Production of Aqueous Polymer Dispersions

(75) Inventors: Reinhold J. Leyrer, Dannstadt-Schauernheim (DE); Dominik Winter, Ludwigshafen (DE); Marc Bothe, Limburgerhof (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/570,043

(22) PCT Filed: Jun. 9, 2005
(86) PCT No.: PCT/EP05/06199

§ 371 Date: Dec. 5, 2006

(30) Foreign Application Priority Data
Jun. 14, 2004 (DE) 10 2004 028 391.5

(51) Int. Cl. C08F 2/08

(52) U.S. Cl. 523/348

(57) ABSTRACT

A process for preparing an aqueous addition-polymer dispersion by free-radically initiated aqueous emulsion polymerization of at least one ethylenically unsaturated monomer in the presence of at least one dispersant and at least one free-radical initiator at a polymerization temperature ≦20° C.

The present invention provides a process for preparing an aqueous polymer dispersion by free-radically initiated aqueous emulsion polymerization of at least one ethylenically unsaturated monomer in the presence of at least one dispersant and at least one free-radical initiator at a polymerization temperature ≦20° C., which comprises
a) initially charging a reaction vessel with
a1) at least one portion of deionized water
a2) at least one portion of the at least one free-radical initiator,
a3) if appropriate a portion of the at least one dispersant and
a4) if appropriate a portion or the total amount of one or more optional auxiliaries and bringing this initial charge to polymerization temperature, then in a first stage
b) supplying the reaction vessel at polymerization temperature over a time period T with
b1) a portion M of the at least one monomer,
b2) if appropriate, portions of the at least one free-radical initiator, of the at least one dispersant, of the optional auxiliary or auxiliaries and/or of deionized water, then
c) if appropriate repeating the actions of the first stage one or more times in corresponding subsequent stages,
c1) the portion of the at least one monomer being chosen such that the portion Mn+1 of the following stage n+1 is greater than the portion Mn of the preceding stage n,
c2) the ratio of the time period Tn+1 of the following stage n+1 to the time period Tn of the preceding stage n being ≧0.5 and ≦2 and
c3) the total amount of all monomer portions amounting to ≦30% by weight, based on the total monomer amount, and then
d) supplying the reaction vessel at polymerization temperature over a time period TP with
d1) the remainder of the at least one monomer,
d2) the remainders if appropriate of the at least one free-radical initiator, of the at least one dispersant, of the optional auxiliary or auxiliaries and/or of deionized water, and
d3) leaving the reaction mixture then at polymerization temperature until at least 90% by weight of the total amount of the at least one monomer has undergone reaction.

Likewise provided by the present invention are the aqueous polymer dispersions obtainable by the process of the invention and the use of the dispersions in various fields of application, and also the polymer powders obtainable from the aqueous polymer dispersions, and their use in various fields of application.

The preparation of aqueous addition-polymer dispersions by free-radically initiated aqueous emulsion polymerization at temperatures ≦20° C. is known in particular in connection with the preparation of synthetic rubber by polymerization of buta-1,3-diene (butadiene) and/or butadiene/styrene mixtures and takes place at low temperatures essentially owing to the preferred 1,4 linkage of the butadiene, the lower rate of butadiene crosslinking and the presence of the butadiene in liquid form (in this regard see, for example, U.S. Pat. No. 2,615,009, GB-A 681032, U.S. Pat. No. 2,680,111, U.S. Pat. No. 2,685,576, U.S. Pat. No. 2,803,623, U.S. Pat. No. 2,803,623, U.S. Pat. No. 2,908,665 or U.S. Pat. No. 2,908,668). The preparation of aqueous polyvinyl chloride dispersions by free-radically initiated aqueous emulsion polymerization of vinyl chloride at temperatures ≦20° C. is also known from the state of the art (in this regard see, for example, DE-A 2019833, FR-A 2086634 and JP-A 05214193).

Additionally known are publications according to which the aqueous emulsion polymerization of other ethylenically unsaturated monomers takes place in a wide temperature range, including temperatures below 20° C., but where the experimentally evidenced free-radically initiated aqueous emulsion polymerizations took place at temperatures well above 20° C. (in this regard see, for example, EP-A 547430, EP-A 857189 or EP-A 1217028). One of the reasons for this is grounded in the fact that for this temperature range the skilled worker is unaware of any polymerization process which ensures a reliable reaction regime—that is, one situated between the “falling asleep” of the polymerization reaction (i.e., its complete cessation, with accumulating concentration of unreacted ethylenically unsaturated monomers) and the “runaway” of the polymerization reaction (i.e., sudden, strongly exothermic reaction of the accumulated ethylenically unsaturated monomers).

It was an object of the present invention to provide a new process for preparing aqueous addition-polymer dispersions that ensures a reliable reaction regime in the free-radically initiated aqueous emulsion polymerization of ethylenically unsaturated monomers at temperatures ≦20° C. A further object was to provide aqueous polymer dispersions whose polymer films exhibit increased mechanical stability in conjunction with low tack.

The object has surprisingly been achieved by means of the process defined at the out-set.

Aqueous polymer dispersions are general knowledge. They are fluid systems comprising as their disperse phase polymer coils, composed of a plurality of intertwined polymer chains and referred to as the polymer matrix or polymer particles, in disperse distribution in the aqueous dispersion medium. The mean diameter of the polymer particles is frequently in the range from 10 to 1000 nm, often 50 to 500 nm or 100 to 300 nm.

The polymer solids content of the aqueous polymer dispersions is generally 20% to 70% by weight.

Aqueous polymer dispersions are obtainable in particular through free-radically initiated aqueous emulsion polymerization of ethylenically unsaturated monomers. This method has been described on numerous occasions before now and is therefore sufficiently well known to the skilled worker [cf., e.g., Encyclopedia of Polymer Science and Engineering, Vol. 8, pages 659 to 677, John Wiley & Sons, Inc., 1987; D. C. Blackley, Emulsion Polymerisation, pages 155 to 465, Applied Science Publishers, Ltd., Essex, 1975; D. C. Blackley, Polymer Latices, 2^{nd} Edition, Vol. 1, pages 33 to 415, Chapman & Hall, 1997; H. Warson, The Applications of Synthetic Resin Emulsions, pages 49 to 244, Ernest Benn, Ltd., London, 1972; D. Diederich, Chemie in unserer Zeit 1990, 24, pages 135 to 142, Verlag Chemie, Weinheim; J. Piirma, Emulsion Polymerisation, pages 1 to 287, Academic Press, 1982; F. Hölscher, Dispersionen synthetischer Hochpolymerer, pages 1 to 160, Springer-Verlag, Berlin, 1969, and patent DE-A 40 03 422]. The free-radically initiated aqueous emulsion polymerization normally takes place such that the ethylenically unsaturated monomers are distributed dispersely in the aqueous medium, generally with use of dispersing assistants, such as emulsifiers and/or protective colloids, and are polymerized by means of at least one water-soluble free-radical polymerization initiator at polymerization temperatures ≧50° C. At polymerization temperatures ≦20° C., however, the process of the invention has proven advantageous.

As at least one ethylenically unsaturated monomer for the free-radically initiated aqueous emulsion polymerization of the invention suitability is possessed in particular by ethylenically unsaturated monomers which are easy to polymerize free-radically, such as ethylene, vinylaromatic monomers, such as styrene, α-methylstyrene, o-chlorostyrene or vinyltoluenes, vinyl halides, such as vinyl chloride or vinylidene chloride, esters of vinyl alcohol and monocarboxylic acids containing 1 to 18 carbon atoms, such as vinyl acetate, vinyl propionate, vinyl n-butyrate, vinyl laurate and vinyl stearate, esters of preferably C₃-C₆ α,βmonoethylenically unsaturated monocarboxylic and dicarboxylic acids, such as especially acrylic acid, methacrylic acid, maleic acid, fumaric acid and itaconic acid, with alkanols containing generally 1 to 12, preferably 1 to 8 and in particular 1 to 4 carbon atoms, such as especially methyl, ethyl, n-butyl, isobutyl, pentyl, hexyl, heptyl, octyl, nonyl, decyl and 2-ethylhexyl acrylate and methacrylate, dimethyl or di-n-butyl fumarate and maleate, nitriles of α,β-monoethylenically unsaturated carboxylic acids, such as acrylonitrile, methacrylonitrile, fumaronitrile and maleonitrile, and C₄₋₈ conjugated dienes, such as butadiene and isoprene, for example. These monomers generally form the principal monomers, which, based on the total monomer amount, account for a fraction of more than 50%, preferably more than 80%, by weight. As a general rule these monomers are only of moderate to low solubility in water under standard conditions [20° C., 1 bar (absolute)].

Monomers which have a heightened solubility in water under the aforementioned conditions are those which contain either at least one acid group and/or the corresponding anion or at least one amino, amido, ureido or N-heterocyclic group and/or ammonium derivatives thereof that are alkylated or protonated on the nitrogen. By way of example mention may be made of α,β-monoethylenically unsaturated monocarboxylic and dicarboxylic acids and their amides such as acrylic acid, methacrylic acid, maleic acid, fumaric acid, itaconic acid, acrylamide and methacrylamide, and also vinylsulfonic acid, 2-acrylamido-2-methylpropanesulfonic acid, styrenesulfonic acid and their water-soluble salts, and also N-vinylpyrrolidone, 2-vinylpyridine, 4-vinylpyridine, 2-vinylimidazole, 2-(N,N-dimethylamino)ethyl acrylate, 2-(N,N-dimethylamino)ethyl methacrylate, 2-(N,N-diethylamino)ethyl acrylate, 2-(N,N-diethylamino)ethyl methacrylate, 2-(N-tert-butylamino)ethyl methacrylate, N-(3-N′,N′-dimethylaminopropyl)methacrylamide and 2-(1-imidazolin-2-onyl)ethyl methacrylate. Normally the aforementioned monomers are used only as modifying monomers, in amounts, based on the total monomer amount, of less than 10%, preferably less than 5%, by weight.

Monomers which customarily raise the internal strength of the films formed from the polymer matrix normally contain at least one epoxy, hydroxyl, N-methylol or carbonyl group or at least two nonconjugated ethylenically unsaturated double bonds. Examples of such are monomers containing two vinyl radicals, monomers containing two vinylidene radicals and monomers containing two alkenyl radicals. Particularly advantageous in this respect are the diesters of dihydric alcohols with α,β-monoethylenically unsaturated monocarboxylic acids, including preferably acrylic and methacrylic acid. Examples of monomers of this kind containing two nonconjugated ethylenically unsaturated double bonds are alkylene glycol diacrylates and dimethacrylates, such as ethylene glycol diacrylate, 1,2-propylene glycol diacrylate, 1,3-propylene glycol diacrylate, 1,3-butylene glycol diacrylate, 1,4-butylene glycol diacrylates and ethylene glycol dimethacrylate, 1,2-propylene glycol dimethacrylate, 1,3-propylene glycol dimethacrylate, 1,3-butylene glycol dimethacrylate, 1,4-butylene glycol dimethacrylate, and also divinylbenzene, vinyl methacrylate, vinyl acrylate, allyl methacrylate, allyl acrylate, diallyl maleate, diallyl fumarate, methylenebisacrylamide, cyclopentadienyl acrylate, triallyl cyanurate or triallyl isocyanurate. Also of particular importance in this context are the C₁-C₈-hydroxyalkyl esters of acrylic and methacrylic acid such as 2-hydroxyethyl, 3-hydroxypropyl or 4-hydroxybutyl acrylate and methacrylate, and also compounds, such as diacetoneacrylamide and acetylacetoxyethyl acrylate and methacrylate. Frequently the aforementioned monomers are used in amounts of up to 10% by weight, but preferably less than 5% by weight, based in each case on the total monomer amount.

Monomer mixtures which can be used with particular advantage in accordance with the invention for the process of the invention are those containing

| | |
|---|---|
| 50% to 99.9% by weight of | esters of acrylic and/or methacrylic acid |
| | with alkanols containing 1 to 12 carbon |
| | atoms and/or styrene, or |
| 40% to 99.9% by weight of | vinyl acetate, vinyl propionate, vinyl |
| | esters of Versatic acid and/or vinyl |
| | esters of long-chain fatty acids. |

In particular it is possible in accordance with the invention to use monomer mixtures containing

| | |
|---|---|
| 0.1% to 5% by weight of | at least one α,β-monoethylenically |
| | unsaturated monocarboxylic or |
| | dicarboxylic acid containing 3 to 6 |
| | carbon atoms, and/or amide thereof, |
| | and |
| 50% to 99.9% by weight of | at least one ester of acrylic and/or |
| | methacrylic acid with alkanols |
| | containing 1 to 12 carbon atoms |
| | and/or styrene, or |
| 0.1% to 5% by weight of | at least one α,β-monoethylenically |
| | unsaturated monocarboxylic or |
| | dicarboxylic acid containing 3 to 6 |
| | carbon atoms, and/or amide thereof, |
| | and |
| 40% to 99.9% by weight of | vinyl acetate, vinyl propionate, vinyl |
| | esters of Versatic acid and/or vinyl |
| | esters of long-chain fatty acids. |

Correspondingly the free-radically initiated aqueous emulsion polymerization of the invention results in polymers composed of the aforementioned monomers in copolymerized form.

It is important that the monomers or monomer mixtures can also be polymerized in the stage or gradient mode, known to the skilled worker, with a varying monomer composition. It may also be noted at this point that for the purposes of this specification the terms monomer and polymer are intended to embrace monomer mixtures and copolymers respectively.

The process of the invention uses at least one dispersant which maintains not only the monomer droplets but also the polymer particles formed during the polymerization in disperse distribution in the aqueous phase and so ensures the stability of the aqueous polymer dispersion produced. Suitable dispersants include not only protective colloids but also emulsifiers.

Examples of suitable protective colloids include polyvinyl alcohols, polyalkylene glycols, alkali metal salts of polyacrylic acids and polymethacrylic acids, cellulose derivatives, starch derivatives and gelatin derivatives or copolymers containing acrylic acid, methacrylic acid, maleic anhydride, 2-acrylamido-2-methylpropanesulfonic acid and/or 4-styrenesulfonic acid, and the alkali metal salts of such copolymers, and also homopolymers and copolymers containing N-vinylpyrrolidone, N-vinylcaprolactam, N-vinylcarbazole, 1-vinylimidazole, 2-vinylimidazole, 2-vinylpyridine, 4-vinylpyridine, acrylamide, methacrylamide, amino-bearing acrylates, methacrylates, acrylamides and/or methacrylamides. An exhaustive description of further suitable protective colloids can be found in Houben-Weyl, Methoden der organischen Chemie, volume XIV/1, Makromolekulare Stoffe [Macromolecular compounds], Georg-Thieme-Verlag, Stuttgart, 1961, pages 411 to 420.

As will be appreciated, mixtures of emulsifiers and/or protective colloids can also be used. Frequently the dispersants used include exclusively emulsifiers, whose relative molecular weights, unlike those of the protective colloids, are situated normally below 1500. The emulsifiers may be anionic, cationic or nonionic in nature. Where mixtures of surface-active substances are used the individual components must of course be compatible with one another, something which in case of doubt can be ascertained by means of a few preliminary tests. Generally speaking, anionic emulsifiers are compatible with one another and with nonionic emulsifiers. The same is true of cationic emulsifiers, whereas anionic and cationic emulsifiers are generally not mutually compatible. An overview of suitable emulsifiers can be found in Houben-Weyl, Methoden der organischen Chemie, volume XIV/1, Makromolekulare Stoffe, Georg-Thieme-Verlag, Stuttgart, 1961, pages 192 to 208.

Examples of customary nonionic emulsifiers include ethoxylated mono-, di- and trialkylphenols (EO units: 3 to 50, alkyl: C₄ to C₁₂) and also ethoxylated fatty alcohols (EO units: 3 to 80; alkyl: C₈ to C₃₆). Examples thereof are the Lutensol® A grades (C₁₂C₁₄ fatty alcohol ethoxylates, EO units: 3 to 8), Lutensol® AO grades (C₁₃C₁₅ oxo alcohol ethoxylates, EO units: 3 to 30), Lutensol® AT grades (C₁₆C₁₈ fatty alcohol ethoxylates, EO units: 11 to 80), Lutensol® ON grades (C₁₀ oxo alcohol ethoxylates, EO units: 3 to 11) and the Lutensol® TO grades (C₁₃ oxo alcohol ethoxylates, EO units: 3 to 20) from BASF AG.

Examples of customary anionic emulsifiers include alkali metal salts and ammonium salts of alkyl sulfates (alkyl: C₈ to C₁₂), of sulfuric monoesters with ethoxylated alkanols (EO units: 4 to 50, alkyl: C₁₂ to C₁₈) and with ethoxylated alkylphenols (EO units: 3 to 50, alkyl: C₄ to C₁₂), of alkylsulfonic acids (alkyl: C₁₂ to C₁₈) and of alkylarylsulfonic acids (alkyl: C₉ to C₁₈).

Compounds which have proven suitable as further anionic emulsifiers include, additionally, compounds of the general formula I 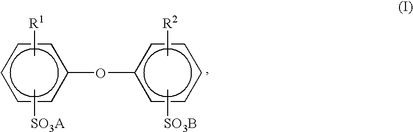
in which R¹ and R² are H atoms or C₄ to C₂₄ alkyl and are not simultaneously H atoms, and A and B can be alkali metal ions and/or ammonium ions. In the general formula I R¹ and R² are preferably linear or branched alkyl radicals having 6 to 18 carbon atoms, especially 6, 12 and 16 carbon atoms, or H, with R¹ and R² not both simultaneously being H atoms. A and B are preferably sodium, potassium or ammonium, particular preference being given to sodium. Particularly advantageous compounds I are those in which A and B are sodium, R¹ is a branched alkyl radical of 12 carbon atoms and R² is a hydrogen atom or R¹. Use is frequently made of technical mixtures having a 50% to 90% by weight fraction of the monoalkylated product, such as Dowfax® 2A1 (brand of the Dow Chemical Company), for example. The compounds I are general knowledge, from U.S. Pat. No. 4,269,749, for example, and are available commercially.

Suitable cationic emulsifiers are, in general, C₆ to C₁₈ alkyl-, aralkyl- or heterocyclyl-containing primary, secondary, tertiary or quaternary ammonium salts, alkanolammonium salts, pyridinium salts, imidazolinium salts, oxazolinium salts, morpholinium salts, thiazolinium salts, and also salts of amine oxides, quinolinium salts, isoquinolinium salts, tropylium salts, sulfonium salts and phosphonium salts. By way of example mention may be made of dodecylammonium acetate or the corresponding hydrochloride, the chlorides or acetates of the various esters of 2-(N,N,N-trimethylammonio)ethylparaffinic acids, N-cetylpyridinium chloride, N-laurylpyridinium sulfate and also N-cetyl-N,N,N-trimethylammonium bromide, N-dodecyl-N,N,N-trimethylammonium bromide, N-octyl-N,N,N-trimethylammonium bromide, N,N-distearyl-N,N-dimethylammonium chloride and also the gemini surfactant N,N′-(lauryldimethyl)ethylenediamine dibromide. Numerous further examples are given in H. Stache, Tensid-Taschenbuch, Carl-Hanser-Verlag, Munich, Vienna, 1981 and in McCutcheon's, Emulsifiers & Detergents, MC Publishing Company, Glen Rock, 1989.

Particular suitability, however, is possessed by nonionic and/or anionic emulsifiers.

In general a total of from 0.05 to 20 parts by weight, frequently from 0.1 to 10 parts by weight and often from 1 to 7 parts by weight of dispersant are used, based in each case on 100 parts by weight of aqueous polymerization medium, consisting of the total amounts of deionized water and the at least one dispersant.

The total amount of the at least one dispersant can be included in the initial charge to the reaction vessel before the addition of the at least one monomer is commenced. It is also possible, however, to include only a portion of the at least one dispersant in the initial charge to the reaction vessel before the addition of the at least one monomer is commenced, and to add the remaining amount during the polymerization. If necessary however, the total amount of the at least one dispersant can also be added in the course of the polymerization. Frequently, the total amount of the at least one dispersant is added in the course of the polymerization, in particular in the form of an aqueous monomer emulsion.

The total amount of deionized water in such a case is such that the polymer solids content of the aqueous polymer dispersion obtained in accordance with the invention amounts to 10% to 80%, frequently 20% to 70% and often 25% to 60% by weight, based in each case on the aqueous polymer dispersion.

The total amount of the deionized water can be included in the initial charge to the reaction vessel before addition of the at least one monomer is commenced. It is, however, also possible to include only a portion of the deionized water in the initial charge to the reaction vessel before the addition of the at least one monomer is commenced, and to add the remaining amount during the polymerization, Frequently ≦75% and often ≦50% or ≦25% by weight of the total amount of deionized water is added in the course of the polymerization, in particular in the form of an aqueous monomer emulsion.

Suitable free-radical polymerization initiators, as they are known, include all those capable of triggering a free-radical aqueous emulsion polymerization at temperatures ≦20° C., They may in principle include both peroxides and azo compounds. As will be appreciated, redox initiator systems are also appropriate, Peroxides which can be used include in principle inorganic peroxides, such as hydrogen peroxide or peroxodisulfates, such as the mono- or di-alkali metal salts or ammonium salts of peroxodisulfuric acid, such as their mono- and di-sodium, -potassium or ammonium salts, for example, or organic peroxides, such as alkyl hydroperoxides, examples being tert-butyl, p-menthyl or cumyl hydroperoxide, and also dialkyl or diaryl peroxides, such as di-tert-butyl peroxide or dicumyl peroxide. As an azo compound use is made essentially of 2,2′-azobis(isobutyronitrile), 2,2′-azobis(2,4-dimethylvaleronitrile) and 2,2′-azobis(amidinopropyl)dihydrochloride (corresponding to V-50 from Wako Chemicals). Suitable oxidizing agents for redox initiator systems are essentially the aforementioned peroxides. Corresponding reducing agents which can be used include sulfur compounds with a low oxidation state, such as alkali metal sulfites, examples being potassium and/or sodium sulfite, alkali metal hydrogensulfites, examples being potassium and/or sodium hydrogensulfite, alkali metal metabisulfites, examples being potassium and/or sodium metabisulfite, formaldehyde sulfoxylates, examples being potassium and/or sodium formaldehyde sulfoxylate, alkali metal salts, especially potassium and/or sodium salts of aliphatic sulfinic acids, and alkali metal hydrogensulfides, such as potassium and/or sodium hydrogensulfide, salts of polyvalent metals, such as iron(II) sulfate, iron(II) ammonium sulfate and iron(II) phosphate, enedioles, such as dihydroxy-maleic acid, benzoin and/or ascorbic acid, and reducing saccharides, such as sorbose, glucose, fructose and/or dihydroxyacetone. In the process of the invention it is preferred to use redox initiator systems. In general the total amount of free-radical initiator amounts to ≧0.05 to ≦6 parts by weight, often ≧0.1 to ≦4 parts by weight and frequently ≧0.25 to ≦3 parts by weight, based in each case on 100 parts by weight of monomers used in total for the polymerization.

The total amount of the at least one free-radical initiator may be included in the initial charge to the reaction vessel before the addition of the at least one monomer is commenced. It is, however, also possible to include only a portion of the at least one free-radical initiator in the initial charge to the reaction vessel before the addition of the at least one monomer is commenced, and to add the remaining amount during the polymerization. Advantageously in accordance with the invention ≧30%, ≧60% or ≧90% by weight of the total amount of free-radical initiator is included in the initial charge to the reaction vessel before the addition of the at least one monomer is commenced, and the remaining amount is added continuously in the course of the polymerization.

It is advantageous if the half-life of the at least one free-radical initiator under polymerization conditions (temperature, pressure, concentration, pH etc.) amounts to ≦12 hours, ≦8 hours or ≦4 hours.

When redox initiator systems are used the proportions of oxidizing agent to reducing agent are familiar to the skilled worker. They amount in general to from 5:1 to 1:5 or from 3:1 to 1:3, frequently from 2:1 to 1:2 or from 15:1 to 1:1.5 and often from 1.3:1 to 1:1.3 or from 1.2:1 to 1:1.2.

If the preferred redox initiator systems are employed then the total amount of the oxidizing agent and/or the reducing agent can be included in the initial charge to the reaction vessel before addition of the at least one monomer is commenced. It is also possible, though, to include only a portion of the oxidizing agent and/or the reducing agent in the initial charge to the reaction vessel before the addition of the at least one monomer is commenced, and to add the remaining amount of the oxidizing agent and/or the reducing agent during the polymerization. Advantageously in accordance with the invention ≧10%, ≧40% or ≧70% by weight of the total amount, or the total amount, of the oxidizing agent and ≧30% by weight, ≧70% by weight or even the total amount of the reducing agent are included in the initial charge to the reaction vessel and the remaining amounts of oxidizing agent and/or reducing agent are added continuously in the course of the polymerization.

As optional auxiliaries use is made, for example, of agents familiar to the skilled worker and selected from free-radical chain transfer compounds, water-soluble organic solvents, polymer seeds, heavy metal compounds, water-soluble macromolecular host compounds which have a hydrophobic cavity and a hydrophilic shell, and also biocides and defoamers.

In the process of the invention free-radical chain transfer compounds (referred to as regulators) are optionally used for the purpose of controlling and/or reducing the molecular weight of the polymers obtainable by the polymerization. Suitable such regulators include essentially aliphatic and/or araliphatic halogen compounds, such as n-butyl chloride, n-butyl bromide, n-butyl iodide, methylene chloride, ethylene dichloride, chloroform, bromoform, bromotrichloromethane, dibromodichloromethane, carbon tetrachloride, carbon tetrabromide, benzyl chloride and benzyl bromide, for example, organic thio compounds, such as primary, secondary or tertiary aliphatic thiols, such as ethanethiol, n-propanethiol, 2-propanethiol, n-butanethiol, 2-butanethiol, 2-methyl-2-propanethiol, n-pentanethiol, 2-pentanethiol, 3-pentanethiol, 2-methyl-2-butanethiol, 3-methyl-2-butanethiol, n-hexanethiol, 2-hexanethiol, 3-hexanethiol, 2-methyl-2-pentanethiol, 3-methyl-2-pentanethiol, 4-methyl-2-pentanethiol, 2-methyl-3-pentanethiol, 3-methyl-3-pentanethiol, 2-ethylbutanethiol, 2-ethyl-2-butanethiol, n-heptanethiol and its isomeric compounds, n-octanethiol and its isomeric compounds, n-nonanethiol and its isomeric compounds, n-decanethiol and its isomeric compounds, n-undecanethiol and its isomeric compounds, n-dodecanethiol and its isomeric compounds, n-tridecanethiol and its isomeric compounds, substituted thiols, such as 2-hydroxyethanethiol, aromatic thiols, such as benzenethiol, ortho-, meta- or para-methylbenzenethiol, for example, and all other sulfur compounds described in the Polymer Handbook 3^{rd} edition, 1939, J. Brandrup and E. H. Immergut, John Wiley & Sons, section II, pages 133 to 141, and additionally aliphatic and/or aromatic aldehydes, such as acetaldehyde, propionaldehyde and/or benzaldehyde, unsaturated fatty acids, such as oleic acid, or hydrocarbons containing readily abstractable hydrogen atoms, such as toluene, for example. It is also possible, however, to use mixtures of aforementioned free-radical chain transfer compounds that do not interfere with one another. The optionally employed total amount of the free-radical chain transfer compounds, based on the total monomer amount, is generally ≦5%, often ≦3% and frequently ≦1% by weight. It is, however, preferred not to use any free-radical chain transfer compounds at all.

The total amount of the free-radical chain transfer compounds can be included in the initial charge to the reaction vessel before the addition of the at least one monomer is commenced, but it is also possible to include only a portion of the free-radical chain transfer compounds in the initial charge to the reaction vessel before addition of the at least one monomer is commenced, and to add the remaining amount during the polymerization. If necessary, however, the total amount of free-radical chain transfer compounds can also be added in the course of the polymerization. In many cases the total amount of free-radical chain transfer compounds is added in the course of the polymerization.

In the process of the invention it is also possible optionally to employ water-soluble organic solvents, such as alcohols, examples being methanol, ethanol, isopropanol, butanols and pentanols, glycols, such as ethylene glycol, diethylene glycol, triethylene glycol, propylene glycol or dipropylene glycol, glycol ethers, such as monomethyl, monoethyl or monobutyl ethers of ethylene glycol, diethylene glycol, triethylene glycol, propylene glycol or dipropylene glycol, for example, and also ketones, such as acetone, etc., as agents for lowering the melting point of the aqueous polymerization medium. The amount of water-soluble organic solvent, based on the aqueous polymerization medium, formed from the total amounts of deionized water and the at least one dispersant, amounts to ≦50%, often ≦25% and frequently ≦10% by weight. Particularly at polymerization temperatures ≧−5° C., ≧0° C. or ≧5° C. a water-soluble organic solvent is generally not used.

The total amount of water-soluble organic solvent can be included in the initial charge to the reaction vessel before the addition of the at least one monomer is commenced. It is, however, also possible to include only a portion of the water-soluble organic solvent in the initial charge to the reaction vessel before addition of the at least one monomer is commenced, and to add the remaining amount during the polymerization. If necessary, however, it is also possible to add the total amount of solvent in the course of the polymerization. In many cases the total amount of water-soluble organic solvent is included in the initial charge to the reaction vessel before addition of the at least one monomer is commenced.

Optionally the free-radically initiated aqueous emulsion polymerization can also take place in the presence of a polymer seed—for example in the presence of from 0.01% to 3%, frequently from 0.02% to 2% and often from 0.04 to 1.5% by weight of a polymer seed, based in each case on the total monomer amount.

A polymer seed is employed especially when the particle size of the polymer particles to be prepared by means of free-radical aqueous emulsion polymerization is to be tailored (in this regard see for example U.S. Pat. No. 2,520,959 and U.S. Pat. No. 3,397,165).

Use is made in particular of polymer seed particles whose size distribution is narrow and whose weight-average diameter D_{w} is ≦100 nm, frequently ≧5 nm to ≦50 nm and often ≧15 nm to ≦35 nm. The determination of the weight-average particle diameters is known to the skilled worker and is accomplished for example by the method of the analytical ultracentrifuge. In this specification the weight-average particle diameter is the weight-average D_{w50} figure determined by the method of the analytical ultracentrifuge (in this regard cf. S. E. Harding et al., Analytical Ultracentrifugation in Biochemistry and Polymer Science, Royal Society of Chemistry, Cambridge, Great Britain 1992, Chapter 10, Analysis of Polymer Dispersions with an Eight-Cell AUC Multiplexer: High Resolution Particle Size Distribution and Density Gradient Techniques, W. Mächtle, pages 147 to 175).

By narrow particle size distribution is meant, for the purposes of this specification, that the ratio of the weight-average particle diameter D_{w50} to the number-average particle diameter D_{N50} [D_{w50}/D_{N50}], as determined by the method of the analytical ultracentrifuge, is ≦2.0, preferably ≦1.5 and with particular preference ≦1.2 or ≦1.1.

Normally the polymer seed is employed in the form of an aqueous polymer dispersion. The aforementioned quantity figures refer to the polymer solids fraction of the aqueous polymer seed dispersion; they are therefore expressed as parts by weight of polymer seed solids, based on the total monomer amount.

If a polymer seed is used then it is advantageous to employ an exogenous polymer seed. Unlike an in situ polymer seed, which is prepared in the reaction vessel before the emulsion polymerization proper is commenced and which has the same monomeric composition as the polymer prepared by the subsequent free-radically initiated aqueous emulsion polymerization, an exogenous polymer seed is a polymer seed which has been prepared in a separate reaction step and whose monomeric composition is different than the polymer prepared by the free-radically initiated aqueous emulsion polymerization, although this means nothing more than that different monomers or monomer mixtures with a different composition are used for preparing the exogenous polymer seed and for preparing the aqueous polymer dispersion. The preparation of an exogenous polymer seed is familiar to the skilled worker and is customarily accomplished by the introduction as initial charge to a reaction vessel of a relatively small amount of monomer(s) and a relatively large amount of emulsifiers and the addition at reaction temperature of a sufficient amount of polymerization initiator.

It is preferred in accordance with the invention to use an exogenous polymer seed having a glass transition temperature ≧50° C., frequently ≧60° C. or ≧70° C. and often ≧80° C. or ≧90° C. Particular preference is given to a polystyrene or polymethyl methacrylate polymer seed.

The total amount of exogenous polymer seed can be included in the initial charge to the reaction vessel before the addition of the at least one monomer is commenced. It is also possible, though, to include only a portion of the exogenous polymer seed in the initial charge to the reaction vessel before addition of the at least one monomer is commenced, and to add the remaining amount during the polymerization. If necessary however, the total amount of polymer seed can be added in the course of the polymerization. Preferably the total amount of exogenous polymer seed is included in the initial charge to the reaction vessel before addition of the at least one monomer is commenced.

It is important that the process of the invention can optionally be carried out additionally in the presence of dissolved heavy metal ions which may be present in changing valences, such as iron, manganese, copper, chromium or vanadium ions, for example. In many cases complexing agents too are added, examples being ethylenediaminetetraacetic acid (EDTA) or nitrilotriacetic acid (NTA), which complex the heavy metal ions and keep them in solution under the reaction conditions. Frequently ≦0.1%, ≦0.05% or ≦0.025% by weight, based in each case on the total monomer amount, of aforementioned water-soluble heavy metal ions are employed in the process of the invention.

The total amount of heavy metal compounds supplying heavy metal ions, frequently heavy metal ion complexes, can be included in the initial charge to the reaction vessel before the addition of the at least one monomer is commenced. It is, however, also possible to include only a portion of the heavy metal compounds in the initial charge to the reaction vessel before addition of the at least one monomer is commenced, and to add the remaining amount during the polymerization. If necessary, though, the total amount of heavy metal compounds can be added in the course of the polymerization. Preferably the total amount of heavy metal compounds is included in the initial charge to the reaction vessel before addition of the at least one monomer is commenced.

Additionally it may be advantageous for at least one water-soluble macromolecular host compound having a hydrophobic cavity and a hydrophilic shell to be present during the polymerization of the at least one ethylenically unsaturated monomer in aqueous medium. By a water-soluble macromolecular host compound is meant, in this specification, host compounds of the kind which at polymerization temperature and polymerization pressure have a solubility of ≧10 g/l deionized water. It is advantageous if the solubility of the macromolecular host compounds under the aforementioned conditions amounts to ≧25 g/l, ≧50 g/l or ≧100 g/l deionized water.

Water-soluble macromolecular host compounds which can be used with advantage include for example calixarenes, cyclic oligosaccharides, noncyclic oligosaccharides and/or derivatives thereof.

Calixarenes which can be used in accordance with the invention are described in U.S. Pat. No. 4,699,966, international patent application WO 89/108092 and also Japanese patents 1988/197544 and 1989/007837.

Cyclic oligosaccharides which can be used include, for example, the cycloinulohexose and -heptose described by Takai et al. in the Journal of Organic Chemistry, 1994, 59 (11), pages 2967 to 2975, but also cyclodextrins and/or derivatives thereof.

Particularly suitable cyclodextrins are α-cyclodextrin, β-cyclodextrin or γ-cyclodextrin and also their methyl, triacetyl, hydroxypropyl or hydroxyethyl derivatives. Particular preference is given to the commercially available underivatized compounds, Cavamax® W6, Cavamax® W7 or Cavamax® W8, the partially methylated compounds Cavasol® W6M, Cavasol® W7M or Cavasol® W8M and the partially hydroxypropylated compounds Cavasol® W6HP, Cavasol® W7HP or Cavasol® W8HP (brand names of Wacker-Chemie GmbH).

Examples of noncyclic oligosaccharides used include starches and/or their degradation products.

The water-soluble starches or starch degradation products frequently comprise native starches which have been rendered water-soluble by boiling with water, or starch degradation products which are obtained from the native starches by hydrolysis, in particular by acid-catalyzed hydrolysis, enzyme-catalyzed hydrolysis or oxidation. Degradation products of this kind are also referred to as dextrins, roast (or torrefaction) dextrins or saccharified starches. Their preparation from native starches is known to the skilled worker and is described for example in G. Tegge, Stärke und Stärkederivate, EAS Verlag, Hamburg 1984, pages 173ff. and pages 220ff. and also in EP-A 0 441 197. Native starches which can be used are virtually all starches of plant origin, examples being starches obtained from corn, wheat, potato, tapioca, rice, sago and common sorghum.

Also used in accordance with the invention are chemically modified starches or starch degradation products. By chemically modified starches or starch degradation products are meant those starches or starch degradation products in which the OH groups are at least partly in derivatized form, e.g., in etherified or esterified form. Chemical modification may be performed not only on the native starches but also on the degradation products. It is also possible to convert chemically modified starches subsequently into their chemically modified degradation products.

The esterification of starch or starch degradation products can take place with not only organic but also inorganic acids, their anhydrides or their chlorides. Customary esterified starches are phosphated and/or acetylated starches or starch degradation products. Etherification of the OH groups can take place, for example, using organic halogen compounds, epoxides or sulfates in aqueous alkaline solution. Examples of suitable ethers are alkyl ethers, hydroxyalkyl ethers, carboxyalkyl ethers, allyl ethers and cationically modified ethers, such as (trisalkylammonio)alkyl ethers and (trisalkylammonio)hydroxyalkyl ethers. Depending on the nature of the chemical modification the starches or starch degradation products may be neutral, cationic, anionic or amphiphilic. The preparation of modified starches and starch degradation products is known to the skilled worker (cf. Ullmann's Encyclopedia of Industrial Chemistry, 5^{th} Ed., vol. 25, pages 12 to 21 and references cited therein).

One embodiment of the present invention uses water-soluble starch degradation products and their chemically modified derivatives obtainable by hydrolysis, oxidation or enzymatic degradation of native starches or chemically modified starch derivatives. Starch degradation products of this kind are also referred to as saccharified starches (cf. G. Tegge, Stärke und Stärkederivate EAS Verlag, Hamburg 1984, pages 220ff.). Saccharified starches and their derivatives are available commercially as such (e.g., C*Pur® products 01906, 01908, 01910, 01912, 01915, 01921, 01924, 01932 or 01934 from Cerestar Deutschland GmbH, Krefeld) or can be prepared by degrading standard commercial starches using known methods: for example, via oxidative hydrolysis with peroxides or enzymatic hydrolysis, starting from the starches or chemically modified starches. Advantage is possessed by starch degradation products obtainable by hydrolysis which have not undergone further chemical modification.

Within the aforementioned embodiment use is made of starch degradation products, with or without chemical modification, having a weight-average molecular weight M_{w} in the range from 1000 to 30 000 daltons and, very preferably, in the range from 3000 to 10 000 daltons. Starches of this kind are fully soluble in water at 25° C. and 1 bar, the solubility limit generally being above 50% by weight, which is particularly favorable for the preparation of the copolymers of the invention in an aqueous medium. Advantageously C*Pur® 01906 (M_{w} approximately 20 000) and C*Pur® 01934 (M_{w} approximately 3000) can be used in particular.

Figures for the molecular weight of the aforementioned starch degradation products chemically modified or otherwise, are based on determinations made by means of gel permeation chromatography under the following conditions:

| | |
|---|---|
| Columns: | 3 steel columns, 7.5 × 600 mm, packed with |
| | TSK-Gel G 2000 PW and G 4000 PW. Pore size 5 μm. |
| Eluent: | deionized water |
| Temperature: | 20 to 25° C. (room temperature) |
| Detection: | differential refractometer (e.g., ERC 7511) |
| Flow rate: | 0.8 ml/min. Pump: (e.g., ERC 64.00) |
| Injection valve: | 20 μl valve: (e.g., VICI 6-way valve) |
| Evaluation: | Bruker Chromstar GPC software |
| Calibration: | Calibration in the low molecular weight range took |
| | place with glucose, raffinose, maltose and |
| | maltopentose. For the higher molecular weight |
| | range pullulan standards were used with a |
| | polydispersity <1.2. |

The amount of water-soluble macromolecular host compound used optionally in the present process of the invention amounts generally to from 0.1% to 50% by weight, often from 0.2% to 20% by weight and frequently from 0.5% to 10% by weight, based in each case on the total monomer amount.

The total amount of water-soluble macromolecular host compound can be included in the initial charge to the reaction vessel before the addition of the at least one monomer is commenced. It is, however, also possible to include only a portion of the water-soluble macromolecular host compound in the initial charge to the reaction vessel before addition of the at least one monomer is commenced, and to add the remaining amount during the polymerization. If desired, however, the total amount of water-soluble macromolecular host compound can also be added in the course of the polymerization. Preferably the total amount of water-soluble macromolecular host compound is included in the initial charge to the reaction vessel before addition of the at least one monomer is commenced.

In accordance with the invention the polymerization temperature is ≦20° C., often ≦15° C., ≦10° C., ≦5° C., ≦0° C. or ≦−5° C. and frequently ≧−30° C., ≧−25° C., ≧−20° C., ≧−15° C., ≧−10° C., ≧−5° C. or ≧0° C. With advantage the polymerization temperature is situated in the range ≧−30° C. and ≦15° C., ≧−20° C. and ≦10° C. or ≧−10° C. and ≦10° C. The reaction mixture is cooled by methods familiar to the skilled worker, such as by means of various cooling brines or liquid ammonia to cool the wall areas of the reaction vessel, or by means of separate cooling coils in the reaction vessel. It is advantageous if the temperature difference between the polymerization temperature and the temperature of the cooling medium amounts to ≧10° C., ≧20° C., ≧30° C., ≧40° C. or ≧50° C. Frequently it is advantageous if the temperature difference between the polymerization temperature and the temperature of the cooling medium amounts to ≧10 to ≦60° C. or ≧20 to ≦40° C.

It is essential to the invention that the reaction vessel is supplied in a first stage at polymerization temperature for a time period T with a portion M of the at least one monomer and, if appropriate, portions of the at least one free-radical initiator, of the at least one dispersant, of the optional auxiliary or auxiliaries and/or of deionized water.

The time period T is advantageously ≧1 minute and ≦30 minutes, ≧5 and ≦20 minutes or ≧5 and ≦10 minutes and the portion M of the at least one monomer is from 0.1% to 5%, often from 0.2% to 3% and frequently from 0.3% to 2% by weight, based in each case on the total monomer amount.

In accordance with the invention, if appropriate, the actions of the first stage are repeated one or more times in corresponding subsequent stages, the portion of the at least one monomer being chosen such that the portion Mn+1 of the following stage n+1 is greater than the portion Mn of the preceding stage n, the ratio of the time period Tn+1 of the following stage n+1 to the time period Tn of the preceding stage n is ≧0.5 and ≦2 and the total amount of all monomer portions amounts to ≦30% by weight, based on the total monomer amount.

Frequently it is advantageous if the actions of the first stage are repeated in subsequent stages one or more times, often one, two, three, four, five, six, seven, eight, nine or ten times (n=1, 2, 3, 4, 5, 6, 7, 8, 9 or 10), with particular advantage at least two, three or four times (n=2, 3 or 4). It is important here that the portion of the at least one monomer is chosen such that the portion Mn+1 of the following stage n+1 is greater than the portion Mn of the preceding stage n. With advantage the monomer portion Mn+1 of the following stage n+1 is from 10% to 300%, frequently from 20% to 200% and often from 50% to 100% by weight above the monomer portion Mn of the preceding stage n. The total amount of all monomer portions amounts to ≦30%, frequently ≦20% and often ≦10% by weight, based in each case on the total monomer amount.

It is likewise important that the ratio of the time period Tn+1 of the following stage n+1 to the time period Tn of the preceding stage n is ≧0.5 and ≦2, frequently ≧0.7 and ≦1.3 or ≧0.9 and ≦1.1, and especially 1.

The monomer portion of the first stage or of the subsequent stages can be supplied to the reaction vessel in each case all at once (“one shot”), discontinuously or continuously. With advantage the addition of the respective monomer portion within the respective time period T takes place continuously with a constant monomer volume flow in each case, the monomer volume flow increasing from stage to stage in accordance with the increase in the monomer portion. It is advantageous in this context if the polymerization conditions (identity and amount of the free-radical initiator, polymerization temperature, identity and amount of the dispersant, etc.) are chosen such that the monomer portions at the end of the time period T have undergone polymerization reaction by ≧70%, preferably ≧80% and with particular preference ≧90% by weight, based in each case on the respective monomer portion, it being possible to verify this in a simple way by means of calorimetric measurements.

Likewise essential to the invention is that the reaction vessel is supplied, directly following the addition of the monomer portions, at polymerization temperature, over a time period TP, with the remainder of the at least one monomer and with the remainder if appropriate of the at least one free-radical initiator, of the at least one dispersant, of the optional auxiliary or auxiliaries and/or of deionized water, and the reaction mixture is then left at polymerization temperature until ≧90%, frequently ≧95% and often ≧98% by weight of the total amount of the at least one monomer has undergone reaction.

The remainder of the at least one monomer can be supplied to the reaction vessel discontinuously or continuously within the time period TP, often continuously with a constant volume flow. The time period TP amounts in general to ≧1 hour and ≦10 hours, frequently ≧2 and ≦8 hours and often ≧3 and ≦6 hours. It is advantageous here if the polymerization conditions (identity and amount of the free-radical initiator, polymerization temperature, identity and amount of the dispersant, etc.) are chosen such that at the end of the time period TP the at least one monomer has undergone polymerization reaction to an extent of ≧70%, preferably ≧80% and with particular preference ≧90% or ≧95% by weight, based in each case on total monomer amount.

It is important, furthermore, that the feed streams referred to in stages b) to d) are supplied to the reaction vessel as cooled feeds, frequently with a temperature which is equal to or lower than the polymerization temperature. Advantageously the temperature of the feed streams is lower than the polymerization temperature, meaning that some of the polymerization energy given off can be utilized for heating the feed streams to polymerization temperature, meaning in turn that it is possible to reduce the size of the cooling areas in or on the reaction vessel and/or to increase the feed rates and hence to lower the overall cycle times. It is also possible for the cooling of the reaction vessel after the total monomer amount has been supplied to be interrupted following the time period TP, meaning that the polymerization energy which may be still given off is able to heat the reaction mixture and may contribute to completing the monomer conversion to ≧80%, ≧90% or ≧95% by weight, based in each case on total monomer amount. It is important, furthermore, that the composition of the monomers employed, such as of the portion(s) during the time period(s) T or the remainder during the time period TP, can be altered discontinuously, in stages or continuously in the course of the process of the invention, thereby allowing the formation of two-phase or multiphase polymer particles or of polymer particles with a gradient morphology.

The process of the invention can be carried out at a pressure lower than, equal to or greater than 1 bar (absolute). The pressure may be 1.2, 1.5, 2, 5, 10 or 15 bar or even higher. Where emulsion polymerizations are conducted under subatmospheric pressure the pressures set are ≦950 mbar, frequently ≦900 mbar and often ≦850 mbar (absolute). Advantageously the free-radical aqueous emulsion polymerization is conducted under an inert gas atmosphere, such as under nitrogen or argon, for example, atmospheric pressure.

Through controlled variation of the monomers it is possible in accordance with the invention to prepare aqueous polymer dispersions whose polymers have a glass transition temperature or a melting point in the range from −60 to 270° C., Frequently the glass transition temperature is ≦−50 to ≦100° C. or ≧−40 to ≦50° C.

By the glass transition temperature T_{g} is meant the limit value of the glass transition temperature toward which T_{g} tends with increasing molecular weight, according to G. Kanig (Kolloid-Zeitschrift & Zeitschrift für Polymere, vol. 190, p. 1, equation 1). The glass transition temperature or the melting point is determined by the DSC method (Differential Scanning Calorimetry, 20 K/min, midpoint measurement, DIN 53765).

According to Fox (T. G. Fox, Bull. Am. Phys, Soc. 1956 [Ser. II] 1, page 123 and in accordance with Ullmann's Encyclopädie der technischen Chemie, vol. 19, page 18, 4^{th} edition, Verlag Chemie, Weinheim, 1980) the glass transition temperature of copolymers with no more than low levels of crosslinking is given in good approximation by:
1/T_{g}=x¹/T_{g}¹+x²/T_{g}²+ . . . xⁿ/T_{g}ⁿ,
where x¹, x², . . . xⁿ are the mass fractions of monomers 1, 2, . . . n and T_{g}¹, T_{g}², . . . T_{g}ⁿ are the glass transition temperatures of the polymers synthesized in each case from only one of the monomers 1, 2, . . . n in degrees Kelvin. The T_{g} values for the homopolymers of the majority of monomers are known and are listed for example in Ullmann's Encyclopedia of Industrial Chemistry, 5^{th} Ed., vol. A21, page 169, VCH Weinheim, 1992; other sources of homopolymer glass transition temperatures include for example J. Brandrup, E. H. Immergut, Polymer Handbook, 1^{st} Ed., J. Wiley, New York 1966, 2^{nd} Ed. J. Wiley, New York 1975, and 3^{rd} Ed. J. Wiley, New York 1989.

The aqueous polymer dispersions obtainable by the process of the invention often contain polymers whose minimum film-forming temperature MFFT amounts to ≦80° C., frequently ≦50° C. or ≦30° C. Since the MFFT can no longer be measured at below 0° C., the lower limit of the MFFT can be indicated only by means of the T_{g} values. The MFFT is determined in accordance with DIN 53787.

The aqueous polymer dispersion obtained normally has a polymer solids content of ≧10% and ≦80%, frequently ≧20% and ≦70% and often ≧25% and ≦60% by weight, based in each case on the aqueous polymer dispersion. The number-average particle diameter (cumulant z-average) as determined by way of quasielastic light scattering (ISO Standard 13 321) is situated in general at between 10 and 2000 nm, frequently between 20 and 1000 nm and often between 100 and 700 nm or from 100 to 400 nm.

Frequently in the case of the aqueous polymer dispersions obtained the residual amounts of unreacted monomers and of other low-boiling compounds are lowered by means of chemical and/or physical methods which are likewise known to the skilled worker [see for example EP-A 771328, DE-A 19624299, DE-A 19621027, DE-A 19741134, DE-A 19741187, DE-A 19805122, DE-A 19828183, DE-A 19839199, DE-A 19840586 and 19847115].

It may also be noted that in many cases the polymers obtainable by the process of the invention, in comparison to the polymers obtainable at temperatures >20° C., combine a higher molecular weight with a lower degree of crosslinking.

In particular it may be noted that the polymers obtainable by the process of the invention, with a glass transition temperature <20° C., have a distinctly lower tack, after a film has been formed from them, than the polymers obtained at higher polymerization temperatures.

The aqueous polymer dispersions obtained in accordance with the invention are often stable for several weeks or months, during which they exhibit in general virtually no phase separation, settling or formation of coagulum at all. They are outstandingly suitable in particular for use as binders in adhesives, sealants, polymer renders, papercoating slips and paints, for finishing leather and textiles, for fiber bonding and for modifying mineral binders.

It may also be noted that the aqueous polymer dispersions obtainable in accordance with the invention can be dried in a simple way to give redispersible polymer powders (e.g. by freeze or spray drying). This is particularly the case when the glass transition temperature of the polymer present in the aqueous polymer dispersion amounts to ≧50° C., often ≧60° C. or ≧70° C., frequently ≧80° C. or ≧90° C. or ≧100° C. The polymer powders are likewise suitable for use as binders in adhesives, sealants, polymer renders, papercoating slips and paints, for finishing leather and textiles, for fiber bonding and, in particular, for modifying mineral binders.

It may further be noted that the polymer films, or polymers in powder form, obtainable from the aqueous polymer dispersions of the invention can have an increased level of ordered regions, especially isotactic and syndiotactic regions, if the monomer mixture used for the polymerization contains ≧10%, ≧50%, ≧80% or even 100% by weight of prochiral ethylenically unsaturated monomers. The ordered, frequently partially crystalline regions differ from the unordered regions in their phase transition temperatures. On differential thermal analysis or on dielectric spectroscopy the polymers of the invention frequently exhibit at least two phase transition temperatures. These may be, for example, two glass transition temperatures or at least one glass transition temperature and one melting point. The existence of at least two transition temperatures in one polymer opens up a path to the preparation of new thermoplastic elastomers which are of interest economically and which were hitherto unavailable via the path of free-radically initiated aqueous emulsion polymerization.

In free-radically initiated aqueous emulsion polymerization at temperatures ≦20° C. the process of the invention ensures a safe mode of operation, allowing accumulating concentration of monomers and their sudden reaction to be reliably avoided in conjunction with short and hence economic polymerization times, which are comparable with or shorter than the polymerization times normally achievable at ≧50° C.

### EXAMPLES

The solids contents were generally determined by drying a defined amount of the aqueous polymer dispersion (approximately 5 g) to constant weight in a drying cabinet at 140° C. Two separate measurements were conducted in each case. The figure reported in the respective examples represents the mean of the two measurement results.

The mean particle diameter of the copolymer particles was determined generally by dynamic light scattering on an aqueous dispersion with a concentration of from 0.005 to 0.01 percent by weight at 23° C. using an Autosizer IIC from Malvern Instruments, England. The figure reported is the mean diameter of the cumulant evaluation (cumulant z-average) of the measured autocorrelation function (ISO Standard 13321).

### Example 1

In a 1 l polymerization reactor with blade stirrer and heating/cooling apparatus at 0° C.

| | | |
|---|---|---|
| 468.0 | g | of deionized water, |
| 1.3 | g | of a 4% strength by weight aqueous solution of an EDTA |
| | | Fe/Na salt (Dissolvine ® E-FE-6, brand name of Akzo |
| | | Nobel), |
| 89.3 | g | of a 7% strength by weight aqueous solution of sodium |
| | | peroxodisulfate and |
| 12.5 | g | of a 5% strength by weight aqueous solution of sodium |
| | | disulfite |

were mixed under a nitrogen atmosphere and stirred for 5 minutes. Then feed stream 1 was metered in at a uniform rate over 6.5 hours, the internal temperature being held continuously at 0° C. Commencing at the same time as feed stream 1, feed stream 2 was started, and within the first 10 minutes 0.5% by weight of feed stream 2, directly thereafter within the next 10 minutes 1.0% by weight of feed stream 2, directly thereafter within the next 10 minutes 1.5% by weight of feed stream 2 and directly thereafter over the course of 5.5 hours the remainder of feed stream 2 was metered in, the additions each taking place at a uniform rate.

Feed stream 1 consisted of 112.5 g of a 5% strength by weight aqueous solution of sodium disulfite.

Feed stream 2 was an aqueous emulsion prepared from

| | | |
|---|---|---|
| 71.0 | g | of deionized water, |
| 5.0 | g | of acrylic acid, |
| 245.0 | g | of n-butyl acrylate and |
| 12.5 | g | of a 15% strength by weight aqueous solution of sodium |
| | | lauryl sulfate. |

After the end of feed stream 1 the reaction mixture was stirred at 0° C. for 15 minutes and then warmed to room temperature (20 to 25° C.).

The resulting aqueous polymer dispersion had a solids content of 26% by weight. The mean particle size was 320 nm.

### Comparative Example 1

Example 1 was repeated but at a polymerization temperature of 50° C.

The resulting aqueous polymer dispersion had a solids content of 26% by weight. The mean particle size was 200 nm.

### Example 2

In a 1 l polymerization reactor with blade stirrer and heating/cooling apparatus at 0° C.

| | | |
|---|---|---|
| 253.0 | g | of deionized water, |
| 2.0 | g | of a 4% strength by weight aqueous solution of Dissolvine ® |
| | | E-FE-6, |
| 57.1 | g | of a 7% strength by weight aqueous solution of sodium |
| | | peroxodisulfate, |
| 152.0 | g | of a 5% strength by weight aqueous solution of sodium |
| | | disulfite and |
| 13.3 | g | of a 15% strength by weight aqueous solution of sodium |
| | | lauryl sulfate |

were mixed under a nitrogen atmosphere and stirred for 5 minutes. Then feed stream 1 was metered in at a uniform rate over 4.5 hours, the internal temperature being held at 0° C. Commencing at the same time as feed stream 1 , feed stream 2 was started, and within the first 10 minutes 0.5% by weight of feed stream 2, directly thereafter within the next 10 minutes 1.0% by weight of feed stream 2, directly thereafter within the next 10 minutes 1.5% by weight of feed stream 2, directly thereafter within the next 10 minutes 2.5% by weight of feed stream 2, directly thereafter within the next 10 minutes 3.5% by weight of feed stream 2 and thereafter over the course of 3 hours and 10 minutes the remainder of feed stream 2 was metered in, the additions each taking place at a uniform rate.

Feed stream 1 consisted of 8 g of a 5% strength by weight aqueous solution of sodium disulfite.

Feed stream 2 was an aqueous emulsion prepared from

| | | |
|---|---|---|
| 97.6 | g | of deionized water, |
| 8.0 | g | of acrylic acid, |
| 392.0 | g | of n-butyl acrylate and |
| 26.7 | g | of a 15% strength by weight aqueous solution of sodium |
| | | lauryl sulfate. |

After the end of feed stream 1 the reaction mixture was stirred at 0° C. for 15 minutes and then warmed to room temperature.

The resulting aqueous polymer dispersion had a solids content of 40% by weight. The mean particle size was 205 nm.

### Comparative Example 2

Example 2 was repeated with the difference that feed stream 2 was to have been metered in at a uniform rate over the course of 4 hours. Approximately 2 hours after commencing feed stream 2, a sudden temperature surge was observed, and it was no longer possible to control the internal temperature of the reaction vessel (the internal temperature increased by 12° C. with the maximum external cooling power). The experiment was discontinued.

### Example 3

In a 1 l polymerization reactor with blade stirrer and heating/cooling apparatus at 0° C.

| | | |
|---|---|---|
| 468.0 | g | of deionized water, |
| 3.8 | g | of a methylated β-cyclodextrin (Cavasol ® W7M |
| | | from Wacker GmbH), |
| 1.3 | g | of a 4% strength by weight aqueous solution of Dissolvine ® |
| | | E-FE-6, |
| 89.3 | g | of a 7% strength by weight aqueous solution of sodium |
| | | peroxodisulfate and |
| 12.5 | g | of a 5% strength by weight aqueous solution of sodium |
| | | disulfite |

were mixed under a nitrogen atmosphere and stirred for 5 minutes. Then feed stream 1 was metered in at a uniform rate over 6.5 hours, the internal temperature being held at 0° C. Commencing at the same time as feed stream 1, feed stream 2 was started, and within the first 10 minutes 0.5% by weight of feed stream 2, directly thereafter within the next 10 minutes 1.0% by weight of feed stream 2, directly thereafter within the next 10 minutes 1.5% by weight of feed stream 2 and directly thereafter over the course of 5.5 hours the remainder of feed stream 2 was metered in, the additions each taking place at a uniform rate.

Feed stream 1 consisted of 112.5 g of a 5% strength by weight aqueous solution of sodium disulfite.

Feed stream 2 was an aqueous emulsion prepared from

| | | |
|---|---|---|
| 71.0 | g | of deionized water, |
| 5.0 | g | of acrylic acid, |
| 245.0 | g | of n-butyl acrylate and |
| 12.5 | g | of a 15% strength by weight aqueous solution of sodium |
| | | lauryl sulfate. |

After the end of feed stream 1 the reaction mixture was stirred at 0° C. for 15 minutes and then warmed to room temperature.

The resulting aqueous polymer dispersion had a solids content of 26% by weight. The mean particle size was 370 nm.

Performance Tests

Production of the Test Specimens

The aqueous dispersions of Examples 1 and 3 and of Comparative Example 1 were poured into a rectangular silicone mold measuring 7.5×16 cm and were dried at room temperature for one week. The amount of aqueous polymer dispersion used in each case was that which gave a polymer film having a layer thickness of 2+/−0.2 mm. The resulting films were clear. Dumbbell test specimens to DIN 53 504, with the S2 dimensions described therein, were produced from the dried films. Because of the highly viscous fluid character of the film formed from the dispersion of Comparative Example 1 it was not possible to obtain any suitable test specimen.

Procedure for Mechanical Measurements

The tensile strength and stress measurements on the aforementioned test specimens were conducted at room temperature using a “zwicki” testing machine from Zwick, Ulm, Federal Republic of Germany, in accordance with DIN 53 504. The results are listed in the table below.

| | Tensile strength | Stress | Stress |
|---|---|---|---|
| Sample | σₘₐₓ [MPa] | σ₅₀ [MPa] | σ₁₂₅ [MPa] |
| Example 1 | 0.15 | 0.10 | 0.12 |
| Example 3 | 0.17 | 0.15 | 0.16 |
| Comparative | *⁾ | *⁾ | *⁾ |
| Example 1 | | | |

*⁾ The nature of the material meant that the production of a test specimen and the subsequent measurement were not possible

1: A process for preparing an aqueous addition-polymer dispersion by free-radically initiated aqueous emulsion polymerization of at least one ethylenically unsaturated monomer in the presence of at east one dispersant and at least one free-radical initiator at a polymerization temperature ≦20° C., comprising
a) initially charging a reaction vessel with
a1) at least one portion of deionized water,
a2) at least one portion of the at least one free-radical initiator,
a3) if appropriate a portion of the at least one dispersant and
a4) if appropriate a portion or the total amount of one or more optional auxiliaries and bringing this initial charge to polymerization temperature, then in a first stage
b) supplying the reaction vessel at polymerization temperature over a time period T with
b1) a portion M of the at least one monomer,
b2) if appropriate, portions of the at least one free-radical initiator, of the at least one dispersant, of the optional auxiliary or auxiliaries and/or of deionized water, then
c) if appropriate repeating the actions of the first stage one or more times in corresponding subsequent stages,
c1) the portion of the at least one monomer being chosen such that the portion Mn+1 of the following stage n+1 is greater than the portion Mn of the preceding stage n,
c2) the ratio of the time period Tn+1 of the following stage n+1 to the time period Tn of the preceding stag n being ≧0.5 and ≦2 and
c3) the total amount of all monomer portions amounting to ≦30% by weight, based on the total monomer amount, and then
d) supplying the reaction vessel at polymerization temperature over a time period TP with
d1) the remainder of the at least one monomer,
d2) the remainders if appropriate of the at least one fee-radical initiator, of the at least one dispersant, of the optional auxiliary or auxiliaries and/or of deionized water, and
d3) leaving the reaction mixture then at polymerization temperature until at least 90% by weight of the total amount of the at least one monomer has undergone reaction.

2: The process according to claim 1, wherein the portion M of the at least one monomer amounts to from 0.1 to 5% by weight, based on the total monomer amount.

3: The process according to claim 1, wherein the monomer portion Mn+1 of the following stage n+1 is from 10% to 300% by weight above the monomer portion Mn of the preceding stage n.

4: The process according to claim 1, wherein the time period T amounts to ≧1 minute and ≦30 minutes.

5: The process according to claim 1 4, wherein the time period TP amounts to ≧1 hour and ≦10 hours.

6: The process according to claim 1, wherein the half-life of the at least one free-radical initiator under polymerization conditions amounts to ≦12 hours.

7: The process according to claim 1, wherein a redox initiator is used as at least one free-radical initiator.

8: The process according to claim 1, wherein the portion of the at least one free-radical initiator charged initially to the reaction vessel amounts to ≧30% by weight, based on the total amount of free-radical initiator.

9: The process according to claim 1, wherein the actions of the first stage are repeated one or more times in corresponding subsequent stages.

10: The process according to claim 1, wherein as at least one optional auxiliary a water-soluble macromolecular host compound is used which has a hydrophobic cavity and a hydrophilic shell.

11: The process according to claim 10, wherein as water-soluble macromolecular host compound a calixarene, a cyclic oligosaccharide, a noncyclic oligosaccharide and/or derivative thereof is used.

12: The process according to claim 11, wherein the cyclic oligosaccharide is an α-, β- and/or γ-cyclodextrin and the non cyclic oligosaccharide is starch and/or a starch degradation product.

13: The process according to claim 1, wherein the polymerization temperature amounts to ≧−10 to ≦10° C.

14: The process according to claim 1, wherein the ratio of the time period Tn+1 to the time period Tn amounts to ≧0.9 and ≦1.1.

15: The process according to claim 1, wherein the resultant aqueous polymer dispersion is subjected to chemical and/or physical aftertreatment for the purpose of removing residual monomers and or low-boiling components.

16: An aqueous polymer dispersion obtained by a process according to claim 1.

17: A binder in adhesives, sealants, polymer renders, papercoating slips or paints, for finishing leather or textiles, for fiber bonding or for modifying mineral binders comprising the aqueous polymer dispersion of claim 16.

18: A polymer powder obtained from an aqueous polymer dispersion according to claim 16.

19: A binder in adhesives, sealants, polymer renders, papercoating slips or paints, for finishing leather or textiles, for fiber bonding or for modifying mineral binders comprising the polymer powder of claim 18.
